(19) United States
(12) Patent Application Publication
(10) Pub. No.: US 2008/0137201 A1
(43) Pub. Date: Jun. 12, 2008

(54) Optical plate having three layers and backlight module with same

(75) Inventors: Tung-Ming Hsu, Tu-cheng (TW); Shao-Han Chang, Tu-cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI Precision Industry CO., LTD., Tu-Cheng City (TW)

(21) Appl. No.: 11/786,913

(22) Filed: Apr. 13, 2007

Related U.S. Application Data
(63) Continuation of application No. 11/620,951, filed on Jan. 8, 2007.

(30) Foreign Application Priority Data
Dec. 8, 2006 (CN) 200610201254.5

(51) Int. Cl. G02B 5/02; F21V 33/00

(52) U.S. Cl. 359/599

(57) ABSTRACT

An exemplary optical plate (20) includes a first transparent layer (21), a second transparent layer (23), and a light diffusion layer (22). The light diffusion layer and the first and second transparent layers are integrally formed, with each of the first transparent and second transparent layers in immediate contact with the light diffusion layer. The light diffusion layer includes a transparent matrix resin (221), and diffusion particles (222) dispersed in the transparent matrix resin. The first transparent layer includes spherical depressions (211) at an outer surface (210) thereof that is farthest from the second transparent layer. The second transparent layer includes protrusions (231) at an outer surface (230) thereof that is farthest from the first transparent layer. Each protrusion is shaped in the form of a square pyramid. An exemplary direct type backlight module (200) using the optical plate is also provided.

### CROSS-REFERENCE TO RELATED APPLICATIONS

This application is related to fourteen copending U.S. patent applications, which are: application Ser. No. 11/620,951 filed on Jan. 8, 2007, and entitled “OPTICAL PLATE HAVING THREE LAYERS”; application Ser. No. 11/620,958, filed on Jan. 8, 2007, and entitled “OPTICAL PLATE HAVING THREE LAYERS AND MICRO PROTRUSIONS”; application Ser. No. 11/623,302, filed on Jan. 5, 2007, and entitled “OPTICAL PLATE HAVING THREE LAYERS”; application Ser. No. 11/623,303, filed on Jan. 15, 2007, and entitled “OPTICAL PLATE HAVING THREE LAYERS AND BACKLIGHT MODULE WITH SAME”; application Ser. No. 11/627,579, filed on Jan. 26, 2007, and entitled “OPTICAL PLATE HAVING THREE LAYERS”; application Ser. No. 11/672,359, filed on Feb. 7, 2007, and entitled “OPTICAL PLATE HAVING THREE LAYERS AND BACKLIGHT MODULE WITH SAME”; application Ser. No. 11/716,323, filed on Mar. 9, 2007, and entitled “OPTICAL PLATE HAVING THREE LAYERS AND BACKLIGHT MODULE WITH SAME”; application Ser. No. 11/716,140, filed on Mar. 9, 2007, and entitled “THREE-LAYERED OPTICAL PLATE AND BACKLIGHT MODULE WITH SAME”; application Ser. No. 11/716,158, filed on Mar. 9, 2007, and entitled “OPTICAL PLATE HAVING THREE LAYERS AND BACKLIGHT MODULE WITH SAME”; application Ser. No. 11/716,143, filed on Mar. 9, 2007, and entitled “OPTICAL PLATE HAVING THREE LAYERS AND BACKLIGHT MODULE WITH SAME”; and application Ser. No. 11/716,141, filed on Mar. 9, 2007, and entitled “OPTICAL PLATE HAVING THREE LAYERS AND BACKLIGHT MODULE WITH SAME”; application serial no. [to be advised], Attorney Docket No. US12891, and entitled “OPTICAL PLATE HAVING THREE LAYERS AND BACKLIGHT MODULE WITH SAME”; application serial no. [to be advised], Attorney Docket No. US12897, and entitled “OPTICAL PLATE HAVING THREE LAYERS AND BACKLIGHT MODULE WITH SAME”; and application serial no. [to be advised], Attorney Docket No. US12898, and entitled “OPTICAL PLATE HAVING THREE LAYERS AND BACKLIGHT MODULE WITH SAME”. In all these copending applications, the inventor is Tung-Ming Hsu et al. All of the copending applications have the same assignee as the present application. The disclosures of the above identified applications are incorporated herein by reference.

### BACKGROUND OF THE INVENTION

1. Field of the Invention

The present invention relates to an optical plate for use in, for example, a backlight module, the backlight module typically being employed in a liquid crystal display (LCD).

2. Discussion of the Related Art

The lightness and slimness of LCD panels make them suitable for use in a wide variety of electronic devices such as personal digital assistants (PDAs), mobile phones, portable personal computers, and other electronic appliances. Liquid crystal is a substance that does not itself emit light. Rather, the liquid crystal relies on receiving light from a light source in order to display data and images. In the case of a typical LCD panel, a backlight module powered by electricity supplies the needed light.

FIG. 10 is a partly exploded, side cross-sectional view of a typical direct type backlight module 100 employing a typical optical diffusion plate. The backlight module 100 includes a housing 11, a plurality of lamps 12 disposed above a base of the housing 11, and a light diffusion plate 13 and a prism sheet 14 stacked on top of the housing 11 in that order. The lamps 12 emit light rays, and inside walls of the housing 11 are configured for reflecting certain of these light rays towards the light diffusion plate 13. The light diffusion plate 13 includes a plurality of dispersion particles embedded therein. The dispersion particles are configured for scattering the light rays, and thereby enhancing the uniformity of light rays output from the light diffusion plate 13. By scattering the light rays, the light diffusion plate 13 can correct what might otherwise be a narrow viewing angle experienced by a user of a corresponding LCD panel (not shown). The prism sheet 14 includes a plurality of V-shaped structures at a top thereof.

In use, light rays from the lamps 12 enter the prism sheet 14 after being scattered in the light diffusion plate 13. The light rays are refracted by the V-shaped structures of the prism sheet 14, and are thereby concentrated somewhat. This increases brightness of light illumination provided by the backlight module 100. Finally, the light rays propagate into the LCD panel (not shown) disposed above the prism sheet 14. However, even though the light diffusion plate 13 and the prism sheet 14 abut each other, a plurality of air pockets still exists at the boundary between them. When the backlight module 100 is in use, light rays pass through the air pockets, and some of the light rays undergo total reflection at one or another of the interfaces at the air pockets. As a result, the light energy utilization ratio of the backlight module 100 is reduced.

Therefore, a new optical means is desired in order to overcome the above-described shortcomings.

### SUMMARY

An optical plate includes a first transparent layer, a second transparent layer, and a light diffusion layer. The light diffusion layer, the first transparent layer and the second transparent layer are integrally formed, with each of the first transparent layer and the second transparent layer in immediate contact with the light diffusion layer. The light diffusion layer includes a transparent matrix resin, and a plurality of diffusion particles dispersed in the transparent matrix resin. The first transparent layer includes a plurality of spherical depressions at an outer surface thereof that is farthest from the second transparent layer. The second transparent layer includes a plurality of protrusions at an outer surface thereof that is farthest from the first transparent layer. Each protrusion includes at least three side surfaces interconnecting with each other. A transverse width of each side surface decreases along a direction away from the light diffusion layer.

Other novel features and advantages will become more apparent from the following detailed description, when taken in conjunction with the accompanying drawings.

### BRIEF DESCRIPTION OF THE DRAWINGS

The components in the drawings are not necessarily drawn to scale, the emphasis instead being placed upon clearly illustrating the principles of the present optical plate and backlight module. Moreover, in the drawings, like reference numerals designate corresponding parts throughout the several views, and all the views are schematic.

FIG. 1 is an isometric view of an optical plate in accordance with a first embodiment of the present invention.

FIG. 2 is a bottom plan view of the optical plate of FIG. 1.

FIG. 3 is a side cross-sectional view of the optical plate of FIG. 1, taken along line III-III thereof.

FIG. 4 is an enlarged view of a circled portion IV of FIG. 1.

FIG. 5 is a top plan view of the optical plate of FIG. 1.

FIG. 6 is an exploded, side cross-sectional view of a direct type backlight module in accordance with a second embodiment of the present invention, the backlight module including the optical plate shown in FIG. 3.

FIG. 7 is a top plan view of an optical plate in accordance with a third embodiment of the present invention.

FIG. 8 is a top plan view of an optical plate in accordance with a fourth embodiment of the present invention.

FIG. 9 is a side cross-sectional view of an optical plate in accordance with a fifth embodiment of the present invention.

FIG. 10 is a partly exploded, side cross-sectional view of a conventional backlight module.

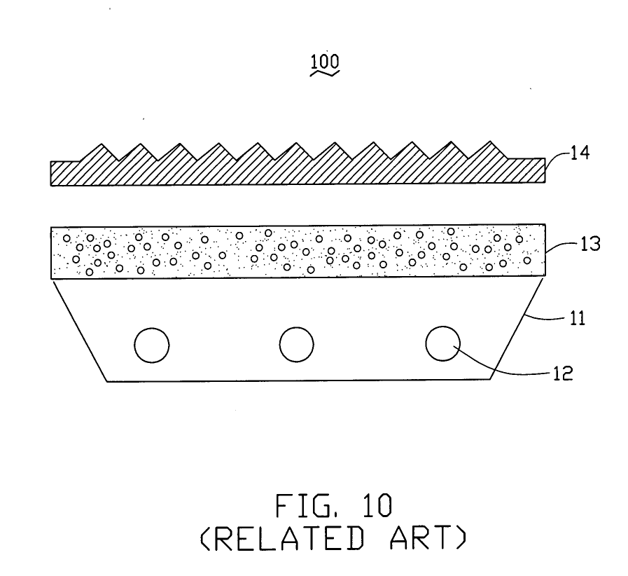

### DETAILED DESCRIPTION OF THE EMBODIMENTS

Reference will now be made to the drawings to describe preferred embodiments of the present optical plate and backlight module, in detail.

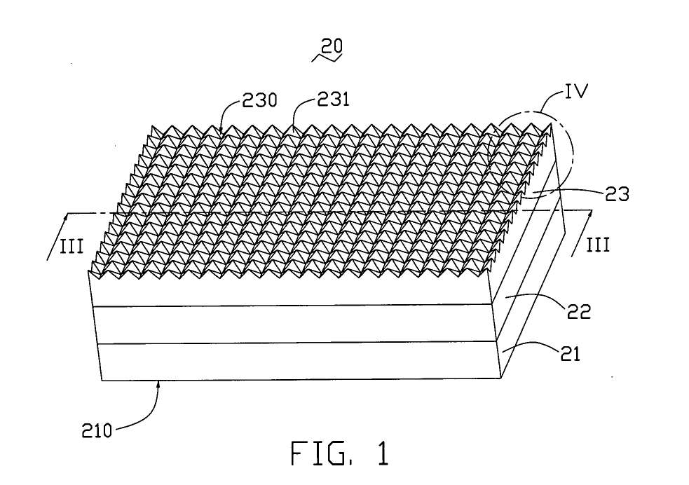

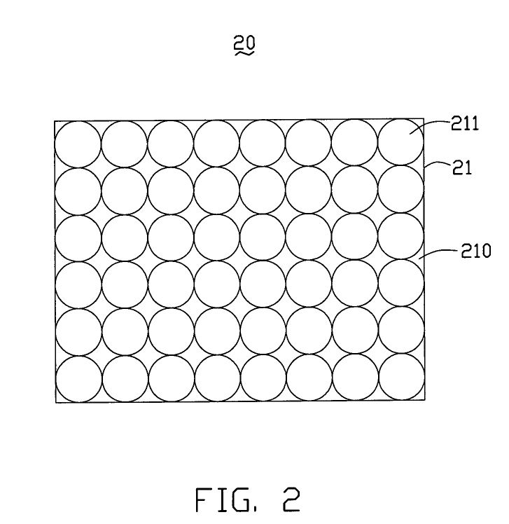

Referring to FIG. 1, an optical plate 20 according to a first embodiment of the present invention is shown. The optical plate 20 includes a first transparent layer 21, a light diffusion layer 22, and a second transparent layer 23. The first transparent layer 21, the light diffusion layer 22, and the second transparent layer 23 are integrally formed as a single body, with the light diffusion layer 22 between the first and second transparent layers 21, 23. The first transparent layer 21 and the light diffusion layer 22 are in immediate contact with each other at a first common interface. Similarly, the second transparent layer 23 and the light diffusion layer 22 are in immediate contact with each other at a second common interface. That is, the optical plate 20 is a unified body, with few or no gaps existing at the common interfaces. The optical plate 20 can be produced by multi-shot injection molding technology. Also referring to FIG. 2, the first transparent layer 21 defines a plurality of spherical depressions 211 at an outer surface 210 that is farthest from the second transparent layer 23. The second transparent layer 23 includes a plurality of protrusions 231 at an outer surface 230 that is farthest from the first transparent layer 21. Each protrusion 231 can include at least three side surfaces interconnecting with each other. In the illustrated embodiment, each protrusion 231 includes four triangular side surfaces 2311 interconnecting with each other. A transverse width of each side surface 2311 decreases along a direction away from the light diffusion layer 22.

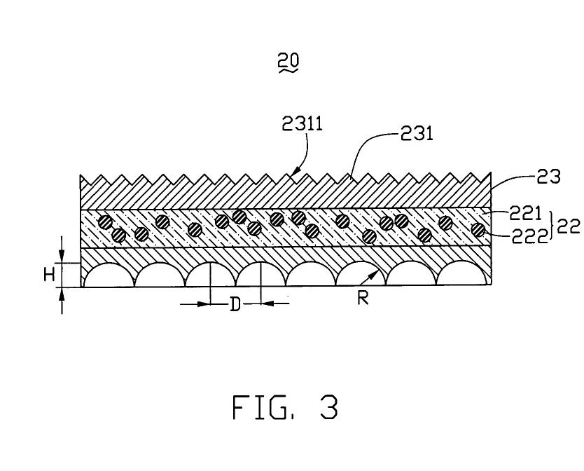

In the illustrated embodiment, the spherical depressions 211 are arranged regularly at the outer surface 210, and adjoin one another. Thus, a regular m×n type matrix of the spherical depressions 211 is formed. Further referring to FIG. 3, to achieve high quality optical effects, a radius R of each spherical depression 211 is preferably in the range from about 0.01 millimeters to about 3 millimeters. A height H of each spherical depression 211 is preferably in the range from about 0.01 millimeters to the radius R. A pitch D between centers of adjacent spherical depressions 211 is preferably in the range from about a half of the radius R to about quadruple the radius R.

The light diffusion layer 22 is configured for enhancing a uniformity of optical output provided by the optical plate 20. The light diffusion layer 22 includes a transparent matrix resin 221, and a plurality of diffusion particles 222 substantially uniformly dispersed in the transparent matrix resin 221. The transparent matrix resin 221 is preferably made of transparent matrix resin selected from the group consisting of polyacrylic acid (PAA), polycarbonate (PC), polystyrene (PS), polymethyl methacrylate (PMMA), methyl methacrylate and styrene copolymer (MS), and any suitable combination thereof. The diffusion particles 222 can be made of material selected from the group consisting of titanium dioxide, silicon dioxide, acrylic resin, and any combination thereof. The diffusion particles 222 are configured for scattering light and enhancing the uniformity of light distribution provided by the light diffusion layer 22. The light diffusion layer 22 preferably has a light transmission ratio in the range from 30% to 98%. The light transmission ratio of the light diffusion layer 22 is determined by a composition of the transparent matrix resin 221 and the diffusion particles 222.

A thickness of each of the first transparent layer 21, the light diffusion layer 22, and the second transparent layer 23 may be greater than or equal to about 0.35 millimeters. In a preferred embodiment, a combined thickness of the first transparent layer 21, the light diffusion layer 22, and the second transparent layer 23 is in the range from about 1.05 millimeters to about 6 millimeters. The first transparent layer 21 and the second transparent layer 23 can each be made of transparent matrix resin selected from the group consisting of polyacrylic acid (PAA), polycarbonate (PC), polystyrene (PS), polymethyl methacrylate (PMMA), methyl methacrylate and styrene copolymer (MS), and any suitable combination thereof. It should be pointed out that the materials of the first and second transparent layers 21, 23 can either be the same or different.

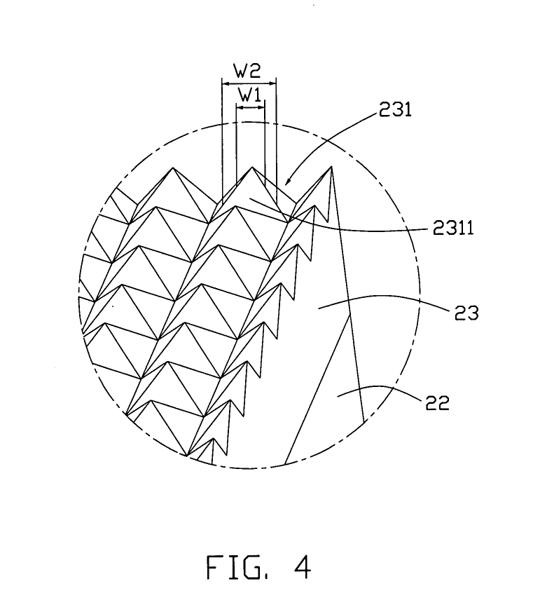

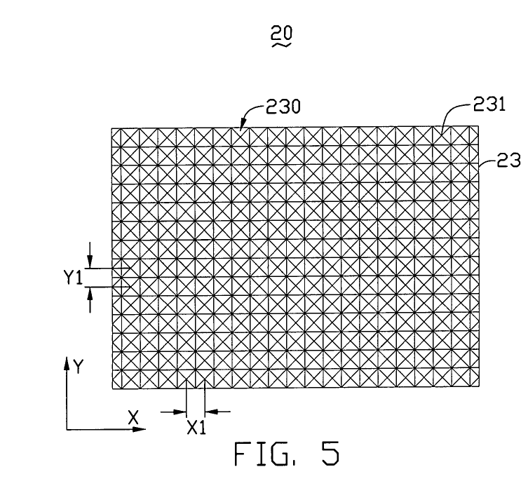

Referring also to FIG. 4, in the illustrated embodiment, each protrusion 231 is shaped in the form of a square pyramid. That is, the protrusion 231 includes the four triangular side surfaces 2311 interconnecting with each other. Any transverse width W1 of each side surface 2311 farther from the light diffusion layer 22 is less than a transverse width W2 of the side surface 2311 nearer to the light diffusion layer 22. Each pair of symmetrically opposite side surfaces 2311 of the protrusion 231 define a dihedral angle (not shown) where they intersect. Thus each protrusion 231 has two dihedral angles defined by the four triangular side surfaces 2311. Each dihedral angle is preferably in the range from about 60 degrees to about 120 degrees. By appropriately configuring one or both of the dihedral angles of the protrusion 231, a desired rate of light enhancement and a desired range of light output angles of the optical plate 20 can be obtained accordingly. Referring also to FIG. 5, the protrusions 231 are arranged regularly at the outer surface 230, and adjoin one another. Thus, a regular m×n type matrix of the protrusions 231 is formed. In a direction parallel to an X-axis, a pitch X1 between centers of adjacent protrusions 231 is in the range from about 0.025 millimeters to about 1 millimeter. In a direction parallel to a Y-axis, a pitch Y1 between centers of adjacent protrusions 231 is in the range from about 0.025 millimeters to about 1 millimeter. It should be pointed out that the pitches X1, Y1 can be either the same or different. In the illustrated embodiment, the pitches X1, Y1 are the same.

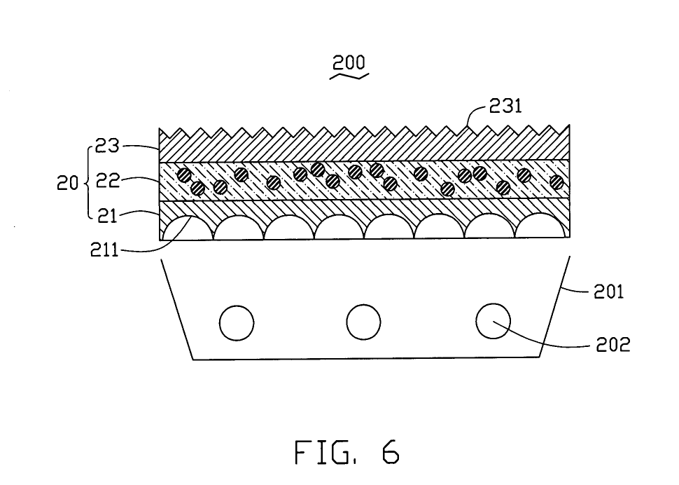

Referring to FIG. 6, a direct type backlight module 200 according to a second embodiment of the present invention is shown. The backlight module 200 includes a housing 201, a plurality of lamp tubes 202, and the optical plate 20. The lamp tubes 202 are regularly arranged above a base of the housing 201. The optical plate 20 is positioned on top of the housing 201, with the first transparent layer 21 facing the lamp tubes 202. It should be pointed out that in an alternative embodiment, the second transparent layer 23 of the optical plate 20 can be arranged to face the lamp tubes 202. That is, light from the lamp tubes 202 can enter the optical plate 20 via a selected one of the first transparent layer 21 and the second transparent layer 23.

In the backlight module 200, when the light enters the optical plate 20 via the first transparent layer 21, the light is first diffused by the spherical depressions 211 of the first transparent layer 21. The diffused light is then further substantially diffused by the light diffusion layer 22 of the optical plate 20. Finally, the diffused light is concentrated by the protrusions 231 of the second transparent layer 23 before exiting the optical plate 20. Therefore, a brightness of the backlight module 200 is increased. In addition, the light is diffused at two levels, so that a uniformity of optical output provided by the optical plate 20 is enhanced. Furthermore, the first transparent layer 21, the light diffusion layer 22, and the second transparent layer 23 are integrally formed together (see above), with few or no air or gas pockets trapped in the respective common interfaces. Thus there is little or no back reflection at the common interfaces, and an efficiency of utilization of light is increased. Moreover, the optical plate 20 in effect replaces the conventional combination of a diffusion plate and a prism sheet. Thereby, a process of assembly of the backlight module 200 is simplified, and an efficiency of assembly is improved. Still further, in general, a volume occupied by the optical plate 20 is less than that occupied by the conventional combination of a diffusion plate and a prism sheet. Thereby, a volume of the backlight module 200 is reduced.

In the alternative embodiment, when the light enters the optical plate 20 via the second transparent layer 23, the uniformity of optical output provided by the optical plate 20 is also enhanced, and the utilization efficiency of light is also increased. Nevertheless, the light emitted from the optical plate 20 via the first transparent layer 21 is different from the light emitted from the optical plate 20 via the second transparent layer 23. For example, when the light enters the optical plate 20 via the first transparent layer 21, a viewing angle provided by the backlight module 200 is somewhat larger than that of the backlight module 200 when the light enters the optical plate 20 via the second transparent layer 23.

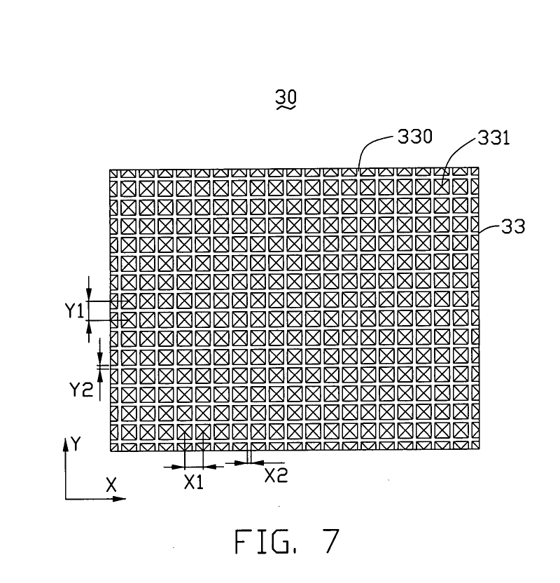

Referring to FIG. 7, an optical plate 30 according to a third embodiment of the present invention is shown. The optical plate 30 is similar in principle to the optical plate 20 of the first embodiment. The optical plate 30 includes a second transparent layer 33, and a plurality of protrusions 331. The protrusions 331 are arranged regularly at an outer surface 330 of the second transparent layer 33, and are uniformly spaced apart from one another. In a direction parallel to an X-axis, a distance X2 between adjacent protrusions 331 is much less than a pitch X1 between adjacent protrusions 331. In a direction parallel to a Y-axis, a distance Y2 between adjacent protrusions 331 is much less than a pitch Y1 between adjacent protrusions 331.

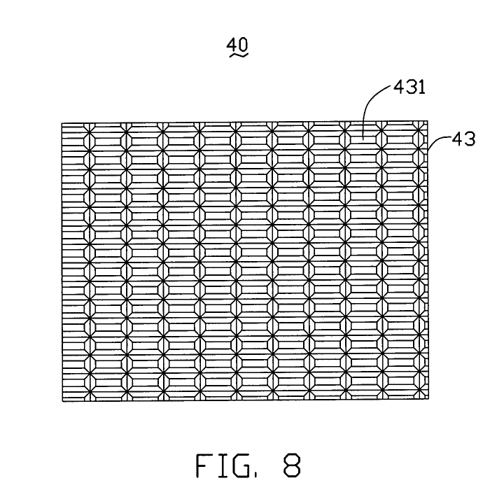

Referring to FIG. 8, an optical plate 40 according to a fourth embodiment of the present invention is shown. The optical plate 40 is similar in principle to the optical plate 20 of the first embodiment. The optical plate 40 includes a second transparent layer 43, and a plurality of protrusions 431. Each protrusion 431 is shaped in the form of a frustum of a rectangular pyramid-like structure. That is, the protrusion 231 includes four isosceles trapezoidal side surfaces and a central, rectangular top surface.

In the above described optical plates 20, 30, and 40, the first common interface between the light diffusion layer and the first transparent layer is planar. Similarly, the second common interface between the light diffusion layer and the second transparent layer is planar. In one kind of alternative embodiment, the first common interface between the light diffusion layer and the first transparent layer may be non-planar. One example of this kind of configuration is given below.

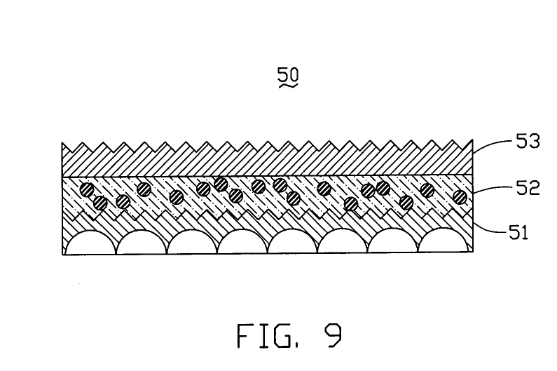

Referring to FIG. 9, an optical plate 50 according to a fifth embodiment of the present invention is shown. The optical plate 50 is similar in principle to the optical plate 20 of the first embodiment. The optical plate 50 includes a first transparent layer 51, a light diffusion layer 52, and a second transparent layer 53. A first common interface (not labeled) between the first transparent layer 51 and the light diffusion layer 52 is a jagged interface. Therefore, a binding strength between the first transparent layer 51 and the light diffusion layer 52 can be improved.

In addition, the present optical plate and backlight module using the optical plate are not limited to the embodiments described above. For example, any one of the optical plates 30, 40 and 50 can substitute the optical plate 20 used in the backlight module 200. In another example, each protrusion can include five or more side surfaces interconnecting with each other. The protrusions and spherical depressions of the above optical plates 20, 30, 40 and 50 are not limited to being arranged regularly in a matrix. The protrusions and spherical depressions can alternatively be arranged according to other suitable patterns, or can instead be arranged randomly. For example, the protrusions can be arranged in rows whereby the protrusions in each row are staggered relative to the protrusions in each of the two adjacent rows. In another similar example, the spherical depressions can be arranged in rows whereby the spherical depressions in each row are staggered relative to the spherical depressions in each of the two adjacent rows.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

1. An optical plate, comprising:
a first transparent layer;
a second transparent layer; and
a light diffusion layer between the first transparent layer and the second transparent layer, the light diffusion layer comprising a transparent matrix resin and a plurality of diffusion particles dispersed in the transparent matrix resin, wherein the first transparent layer, the light diffusion layer, and the second transparent layer are integrally molded together, with the first transparent layer in immediate contact with the light diffusion layer and the second transparent layer in immediate contact with the light diffusion layer such that there are no air or gas pockets trapped between the first transparent layer and the light diffusion layer nor between the second transparent layer and the light diffusion layer, and the first transparent layer comprises a plurality of spherical depressions at an outer surface thereof that is farthest from the second transparent layer, the second transparent layer comprises a plurality of protrusions at an outer surface thereof that is farthest from the first transparent layer, each protrusion comprises at least three side surfaces connecting with each other, and a transverse width of each side surface decreases along a direction away from the light diffusion layer.

2. The optical plate as claimed in claim 1, wherein a thickness of each of the light diffusion layer, the first transparent layer, and the second transparent layer is greater than or equal to about 0.35 millimeters.

3. The optical plate as claimed in claim 2, wherein a combined thickness of the light diffusion layer, the first transparent layer and second transparent layer is in the range from about 1.05 millimeters to about 6 millimeters.

4. The optical plate as claimed in claim 1, wherein the transparent matrix resin of the light diffusion layer is made of material selected from the group consisting of polyacrylic acid, polycarbonate, polystyrene, polymethyl methacrylate, methyl methacrylate and styrene copolymer, and any combination thereof.

5. The optical plate as claimed in claim 1, wherein a material of the diffusion particles is selected from the group consisting of titanium dioxide, silicon dioxide, acrylic resin, and any combination thereof.

6. The optical plate as claimed in claim 1, wherein each of the first transparent layer and the second transparent layer is made of material selected from the group consisting of polyacrylic acid, polycarbonate, polystyrene, polymethyl methacrylate, methyl methacrylate and styrene copolymer, and any combination thereof.

7. The optical plate as claimed in claim 1, wherein each of the protrusions is shaped in the form of a square pyramid or a rectangular pyramid.

8. The optical plate as claimed in claim 7, wherein an angle defined between a first pair of opposite side surfaces of each protrusion is in the range from about 60 degrees to about 120 degrees, and an angle defined between a second pair of opposite side surfaces of each protrusion is in the range from about 60 degrees to about 120 degrees.

9. The optical plate as claimed in claim 1, wherein the protrusions are arranged regularly at the light output surface in a matrix, and adjoin one another.

10. The optical plate as claimed in claim 1, wherein the protrusions are arranged regularly at the light output surface in a matrix, and are spaced apart from one another.

11. The optical plate as claimed in claim 1, wherein a pitch between centers of adjacent protrusions is in the range from about 0.025 millimeters to about 1 millimeter.

12. The optical plate as claimed in claim 1, wherein each of the protrusions is shaped in the form of a frustum of a rectangular pyramid-like structure.

13. The optical plate as claimed in claim 1, wherein the spherical depressions are arranged regularly at the outer surface of the first transparent layer in a matrix, and adjoin one another

14. The optical plate as claimed in claim 1, wherein at least one of the following interfaces is planar: an interface between the light diffusion layer and the first transparent layer, and an interface between the light diffusion layer and the second transparent layer.

15. The optical plate as claimed in claim 1, wherein at least one of the following interfaces is jagged: an interface between the light diffusion layer and the first transparent layer, and an interface between the light diffusion layer and the second transparent layer.

16. A direct type backlight module, comprising:
a housing;
a plurality of light sources disposed on or above a base of the housing; and
an optical plate disposed above the light sources at a top of the housing, the optical plate comprising:
a first transparent layer;
a second transparent layer; and
a light diffusion layer between the first transparent layer and the second transparent layer, the light diffusion layer comprising a transparent matrix resin and a plurality of diffusion particles dispersed in the transparent matrix resin, wherein the first transparent layer, the light diffusion layer, and the second transparent layer are integrally molded together with the first transparent layer in immediate contact with the light diffusion layer and the second transparent layer in immediate contact with the light diffusion layer such that there we no air or gas pockets trapped between the first transparent layer and the light diffusion layer nor between the second transparent layer and the light diffusion layer, and the first transparent layer comprises a plurality of spherical depressions at an outer surface thereof that is farthest from the second transparent layer, the second transparent layer comprises a plurality of protrusions at an outer surface thereof that is farthest from the first transparent layer, each protrusion comprises at least tree side surfaces connecting with each other, and a transverse width of each side surface decreases along a direction away from the light diffusion layer.

17. The direct type backlight module as claimed in claim 16, wherein a selected one of the first transparent layer and the second transparent layer of the optical plate is arranged to face the light sources.

18. An optical plate, comprising:
a first transparent layer;
a second transparent layer; and
a light diffusion layer between the first transparent layer and the second transparent layer, the light diffusion layer including a transparent matrix resin and a plurality of diffusion particles dispersed in the transparent matrix resin, wherein the light diffusion layer, the first transparent layer, and the second transparent layer are integrally molded together as a single body, with the first transparent layer gaplessly in contact with the light diffusion layer and the second transparent layer gaplessly in contact with the light diffusion layer such that there are no air or gas pockets trapped between the first transparent layer and the light diffusion layer nor between the second transparent layer and the light diffusion layer, and the first transparent layer comprises a plurality of spherical depressions at an outer surface thereof that is farthest from the second transparent layer, the second transparent layer comprises a plurality of protrusions at an outer surface thereof that is farthest from the first transparent layer, each protrusion comprises at least three side surfaces connecting with each other, and a transverse width of each side surface decreases along a direction away from the light diffusion layer.
